(19) United States
(12) Patent Application Publication
(10) Pub. No.: US 2010/0085959 A1
(43) Pub. Date: Apr. 8, 2010

(54) SYSTEM AND METHOD FOR ACHIEVING INTEROPERABILITY BETWEEN ENDPOINTS OPERATING UNDER DIFFERENT PROTOCOLS

(75) Inventors: Sumeet Vohra, San Mateo, CA (US); Chris Lauwers, Mountain View, CA (US); Vladimir Vysotsky, Fremont, CA (US); Shiauchiang Wu, San Jose, CA (US)

Correspondence Address: SUGHRUE MION, PLLC, 2100 PENNSYLVANIA AVENUE, N.W., SUITE 800, WASHINGTON, DC, 20037, US

(73) Assignee: Avistar Communications Corporation, San Mateo, CA (US)

(21) Appl. No.: 12/572,226

(22) Filed: Oct. 1, 2009

Related U.S. Application Data
(60) Provisional application No. 61/194,921, filed on Oct. 1, 2008.

(51) Int. Cl. H04L 12/66; G06F 15/16

(52) U.S. Cl. 370/352; 709/228

(57) ABSTRACT

A teleconferencing system for achieving interoperability between a multiple endpoints including a first endpoint following SIP protocol, a second endpoint following H.323 protocol and a third endpoint following a proprietary protocol. The teleconferencing system incorporates a signaling gateway and a call control server. In the teleconferencing system, the signaling gateway and a call control server are configured to perform policy-based management of calls between the first endpoint, the second endpoint and the third endpoint.

### CROSS-REFERENCE TO RELATED APPLICATION

This regular U.S. patent application claims the benefit of priority under 35 U.S.C. 119 of U.S. provisional patent application No. 61/194,921 filed Oct. 1, 2008, the entire disclosure of which is incorporated by reference herein.

### BACKGROUND OF THE INVENTION

1. Field of the Invention

This invention relates in general to systems and methods for teleconferencing and, more specifically, for teleconferencing systems and methods providing interoperability between teleconferencing endpoints that operate according to different signaling protocols.

2. Description of the Related Art

There exist many teleconferencing systems that have endpoints operating in accordance with different signaling protocols, including standard-based protocols such as SIP and H.323, as well as variety of proprietary signaling protocols. Such diversity of the teleconferencing standards presents interoperability problem, wherein the systems cannot interoperate with one another. Existing interoperability solutions concentrate on real-time conversion of the media stream from one protocol to another, which results in latency issues, which degrade teleconferencing system performance and user experience.

Therefore, there is a need for systems and methods that would enable interoperability between teleconferencing systems operating under different protocols without compromising overall system performance.

### SUMMARY OF THE INVENTION

The inventive methodology is directed to methods and systems that substantially obviate one or more of the above and other problems associated with conventional techniques for achieving interoperability between endpoints of teleconferencing system, which operate according to different protocols.

In one aspect of the present invention, there is provided a teleconferencing system for achieving interoperability between at least two of a first endpoint following SIP protocol, a second endpoint following H.323 protocol and a third endpoint following a proprietary protocol, the teleconferencing system including a signaling-only gateway and a call control server. The signaling-only gateway and a call control server are operable to perform policy-based management of calls between the at least two of the first endpoint, the second endpoint and the third endpoint, enabling a direct flow of media data between respective endpoints.

In another aspect of the present invention, there is provided a method for achieving interoperability between at least two of a first endpoint following SIP protocol, a second endpoint following H.323 protocol and a third endpoint following a proprietary protocol. The method is being performed by a teleconferencing system including a signaling-only gateway and a call control server. The inventive method involves performing policy-based management of calls between the at least two of the first endpoint, the second endpoint and the third endpoint using the signaling-only gateway and the call control server to enable a direct flow of media data between respective endpoints.

In yet another aspect of the present invention, there is provided a computer-readable medium embodying computer-executable instructions, which, when executed by one or more processors of a teleconferencing system incorporating a signaling-only gateway and a call control server, are operable to cause the one or more processors to perform a method for achieving interoperability between at least two of a first endpoint following SIP protocol, a second endpoint following H.323 protocol and a third endpoint following a proprietary protocol. The inventive method involves performing policy-based management of calls between the at least two of the first endpoint, the second endpoint and the third endpoint using the signaling-only gateway and the call control server to enable a direct flow of media data between respective endpoints.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an embodiment of the inventive system architecture at the interface level.

FIG. 2 illustrates transferring a call with an external H.323 endpoint according to an embodiment of the inventive concept.

FIG. 3 illustrates operation of the inventive signaling-only gateway in conjunction with a Call Control Server.

FIG. 4 illustrates the INVITE processing for DID, and the relevant response codes.

FIG. 5 illustrates pre-routing of the call in accordance with an embodiment of the inventive concept.

FIG. 6 illustrates redirecting the inbound call from an external H.323 endpoint to another instance of the SIP-H.323 gateway deployed elsewhere according to an embodiment of the invention.

FIG. 7 illustrates the procedure for transferring an H.323 endpoint (X) from one SIP endpoint (A) to another (B).

FIG. 8 illustrates SIP-side call redirection in accordance with an embodiment of the inventive concept.

FIG. 9 illustrates the end-to-end H.323 call redirection.

FIG. 10 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Aspects of the invention deal with teleconferencing architecture achieving interoperability between endpoints that follow different signaling protocols.

Interoperability Between SIP, H.323 & Proprietary Endpoints Using a Signaling-Only Gateway & Third-Party Call Control Server

Embodiments of the invention introduce native support for SIP, H.323 and proprietary signaling protocols in a network and call management infrastructure of a teleconferencing system. Specifically, the inventive concept provides several infrastructure components that allow for interoperability between audio/video endpoints that follow different protocols for call setup and session management, including the following types of audio/video endpoints:

1. A variety of third-party SIP audio/video endpoints,

2. and a variety of third-party H.323 audio/video endpoints,

3. as well as proprietary endpoints.

In an embodiment of the invention, this seamless interoperability is implemented using an inventive SIP-H.323 Signaling-only Gateway) also referred to herein as Signaling Gateway) and a commercially available call control server. The following discussion assumes familiarity with video telephony protocols, especially H.323 and SIP.

1. A Brief Overview of an Embodiment of Invention

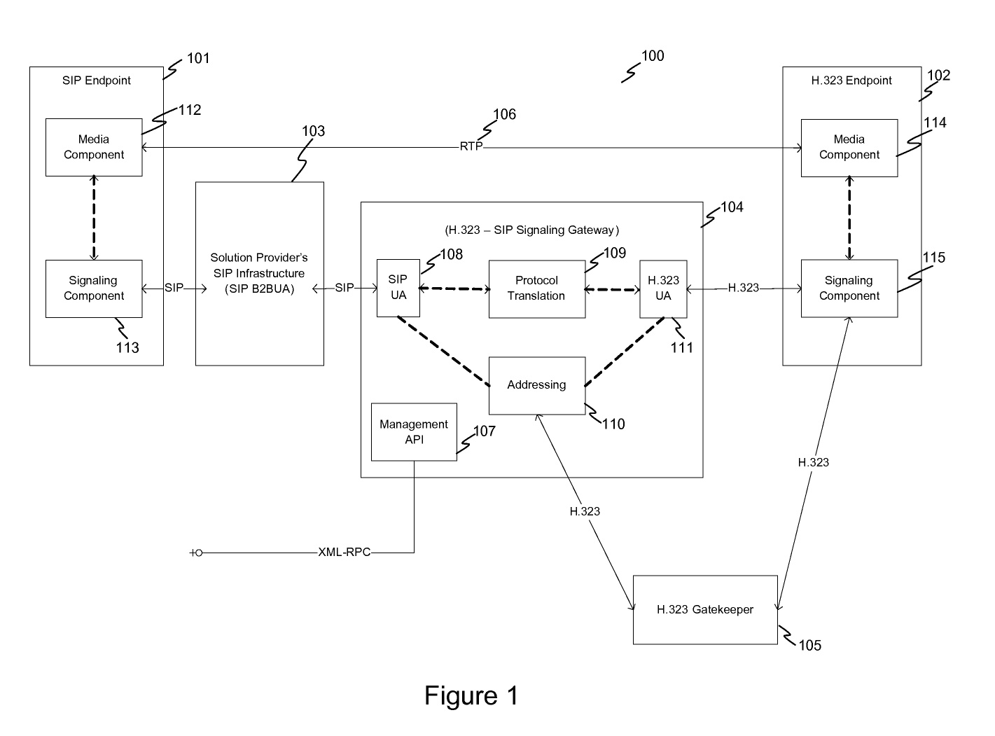

Standards-based video endpoints use signaling protocols such as SIP or H.323 as part of their call setup process. The media itself is typically sent over RTP/RTCP (106 in FIG. 1) in the form of compressed media streams, which use compression standards such as G.722, H.263, or H.264, among others. The target consumers for the SIP-H.323 Signaling-only Gateway are providers of such video conferencing endpoints, or infrastructure for services, or both.

An embodiment of the invention is a SIP-H.323 Signaling-only Gateway, which performs the necessary handling of the SIP and H.323 signaling protocols and protocol translation between them, in either direction. We generally refer to the SIP-to-H.323 call direction as “outbound” calls, while the reverse, viz. the H.323-to-SIP call direction is referred to as “inbound” calls. While the SIP-H.323 Signaling Gateway participates in the establishment of calls, it does not directly deal with the RTP media streams exchanged in the context of the call. The media is streamed directly between the peer endpoints. FIG. 1 illustrates an embodiment of the inventive system architecture 100 at the interface level. The management API 107 is based on XML-RPC.

Interoperability with proprietary endpoints 101 and 102 is achieved by the SIP infrastructure 103, which is also used for third-party call control. The respective endpoints incorporate media components 112 and 114 and signaling components 113 and 115. The usage of the proprietary protocol is limited between the SIP endpoint and the third-party call control server, while the server uses SIP for signaling with the Signaling Gateway 104 component. In certain configurations, the SIP infrastructure may also be a SIP registrar, commonly known as a SIP server. A Gatekeeper 105 is typically deployed on the H.323 side.

As can be seen from the above FIG. 1, the SIP-H.323 Signaling-only Gateway 104 implements a SIP User Agent (UA) 108, to allow the placement or forwarding of outbound calls; and to provide inbound call notifications, thereby allowing their acceptance or refusal by the SIP infrastructure; to handle SIP error conditions; and to handle call/session termination.

Similarly, the SIP-H.323 Signaling-only Gateway implements an H.323 stack to serve as an agent 111 for external H.323 endpoints. The Gateway 104 performs the necessary protocol translation 109 and maintains the H.323 and SIP sessions in harmonized states. Additionally, it registers with a Gatekeeper 105 as an H.323 Gateway, if configured to do so, in managed H.323 environments. In an embodiment, the addressing component 110 performs address translation between protocols.

2. Exemplary Features

Some exemplary features of the inventive Gateway component are listed below:
Implement a H.323 Gateway, presenting a set of H.323 endpoints on the H.323 network with or without a Gatekeeper, by implementing client-side RAS, H.225.0 Call Signaling & H.245 Call Control procedures. An embodiment of the invention supports H.323 versions 4 and greater (including version 5).
Act as a source and destination of SIP sessions by implementing a SIP endpoint. An embodiment of the invention supports SIP version 2.0, as specified in RFC 3261.
Not implement RTP or media coding, relying on the usage of standard codecs in the media plane, as conveyed by the SIP and H.323 endpoints in the session-level signaling.
Maintain the mapping and interoperability of H.323 and SIP calls in the signaling plane.
Provide the necessary configuration, logging and monitoring functionality.
Interoperability testing and support for currently shipping versions of several third-party SIP and H.323 endpoints.

The telecom industry has been witness to a competition between multiple network protocols, especially in the voice and video communications marketplace. For any protocols not supported natively by endpoints and infrastructure components (such as SIP, H.323, XMPP, SCCP or any other emerging public or proprietary standards), it makes a lot of sense to deploy signaling-only gateways to be available as parts of a distributed infrastructure.

Unlike call signaling, media coding transmission should deal with a smaller and slowly changing set of standards, namely, RTP/RTCP, G and H-series media codecs. Since most existing endpoints (voice and video phones) already use RTP and ITU-defined codecs for media compression and transmission, the signaling-only gateway makes it possible for these endpoints to participate in calls with other types of endpoints, while exchanging media streams directly between the different endpoints. For example, a SIP endpoint and an H.323 endpoint could participate in a call with the signaling being routed through the gateway, while the media flows directly between the endpoints. This provides the best possible media experience, while reducing latency and loss of information due to transcoding.

In cases where this will not be possible, the media streams can be routed through transcoders, media relays, or firewall traversal tools, as needed to resolve protocol, codec and transport problems. In separation of the signaling problem and delegating it to the signaling-only gateway, makes it possible to address the optimum media experience, separately. The signaling-only gateways and media relays also take care of orthogonal issues such as authentication, encryption, compliance enforcement etc. Some features, notably anything to do with administration of the system, scale better if they are centralized. Reliable accounting and reporting is another area where infrastructure support is useful. For all of these reasons, the architectural choice for the addition of a signaling-only gateway in the infrastructure provides clear performance or quality benefits.

3. SIP and H.323 Signaling for Audio/Video Calls

A. Supported Media Types

In an embodiment, an SIP-H.323 Signaling Gateway 104 enables direct media connectivity between H.323 and SIP endpoints 102 and 101. The media itself is sent using RTP/RTCP 106 in the form of compressed G.722, H.263, or H.264 compressed streams. The endpoint codec compatibility check is implemented by a proprietary, or standalone SIP endpoint and/or the SIP User Agent in the SIP Server 103 on one side; and the external H.323 endpoint on the other side. At the same time, a SIP-H.323 Gateway 104 acts as a conduit to enable this functionality. It does so by passing through the relevant information, after providing the necessary translation between H.245 media management procedures on one side; and SIP INVITE/re-INVITE transactions with appropriate SDP payloads on the other side. The SDP payload in the SIP messages carries all relevant media information communicated by the endpoint, such as the codecs supported by the endpoint, annexes supported by the codecs (or profiles depending on the particular codec), media characteristics such as supported picture resolution, etc. Media renegotiation is also supported in the same manner over the SIP and the H.323 signaling protocols, by using re-INVITEs and logical channel manipulation, in respective order.

B. Call Control

Multiple instances (up to several hundred) of SIP and H.323 calls are supported by a single instance of the SIP-H.323 Gateway. The call control functionality enables SIP and H.323 endpoints to place calls to each other, to accept, refuse and hangup calls, or to hold and resume active calls. Additionally, it enables transferring an established call to another endpoint.

In an embodiment, the gateway provides basic calling functionality between SIP endpoints and H.323 endpoints in the following manner:

1. It forwards an incoming SIP call to an H.323 destination. An IP address, an alias or a combination of the two is supported for specifying the destination address. The gateway places an outgoing H.323 call to accomplish this. It should be noted that a combination of the IP address and alias will typically use a separator of “##’ preceding the numeric E.164 alias string; and it will be passed to the third party H.323 systems for possible usage, such as direct dialing.

2. Similarly, in an embodiment, the gateway forwards an incoming H.323 call to a SIP destination, by placing an outgoing SIP call.

3. In either of the above cases, the gateway may translate between H.245 call control procedures and SIP INVITE/re-INVITE transactions with appropriate SDP payloads. In an embodiment, the gateway supports the fast connect procedure, as well as the regular connect, if required by the H.323 endpoint. Specifically, the H.245 logical channel manipulation is translated to SIP re-invites with updated SDP.

4. In an embodiment, H.245 bandwidth management is also translated to SIP, using appropriate SDP payload. For example, the gateway supports requests for *downspeeding* that are initiated by the H.323 endpoint. The Gateway is responsible for managing the differences between SIP and H.323 protocols for call control.

5. In an embodiment, H.245 mechanisms such as master-slave determination and conference control for distributed multiparty conferences, that are not directly addressed by SIP, the H.323 UA portion of the Gateway supports these, in a manner that is transparent to the SIP endpoint.

6. In an embodiment, the gateway allows either endpoint to terminate a connected SIP/H.323 call.

7. In an embodiment, the gateway handles any relevant error conditions including SIP or H.323 errors, timeouts, or unexpected call termination. Both, the SIP and H.323 peers are notified of such conditions, as appropriate.

8. In an embodiment, the gateway allows the handling of media incompatibility between SIP and H.323 endpoints. It may do so, for example, by providing the necessary translation between H.245 media management procedures on one side; and SIP INVITE/re-INVITE transactions with appropriate SDP payloads on the other. The actual determination of media compatibility is performed directly at the endpoints, while the gateway translates and propagates these decisions across protocol boundaries.

9. In an embodiment, in the event where no compatible media is available between the endpoints, the third-party call control server induces a media relay and/or transcoder in the media path.

10. In an embodiment, the gateway allows SIP and H.323 endpoints to control the session using SIP re-INVITEs and H.254 channel manipulation, respectively. It also supports other SIP message types including at least INVITE, ACK, CANCEL, BYE, INFO, OPTIONS, REFER, REGISTER and SUBSCRIBE/NOTIFY. This allows for registration and atomic transfer operations.

In an embodiment, the Gateway may support Hold and Resume functionality for SIP and H.323 calls. In an embodiment, the gateway also allows transferring an H.323 endpoint to a different SIP endpoint.

1. In an embodiment, the gateway allows an endpoint to hold or resume a connected SIP-H.323 call.

2. On the H.323 side, the gateway may support the Phase D Call services defined in H.323 V5 Section 8.4. In an embodiment, the gateway may support Hold/Resume initiated by the H.323 endpoint using the procedure laid out in H.323 V5 section 8.4.6 for third party initiated pause. In an embodiment, the gateway translates this into appropriate SIP transactions. Specifically, the gateway sends a SIP re-INVITE with modified SDP to reflect the held/active session description. It is noted that H.450.4 also defines a supplementary mechanism for Call Hold. In an embodiment, the gateway supports H.450.4, as an optional service, which does not necessarily cause a change in the session description (SDP).

3. On the SIP side, the gateway may support Hold/Resume initiated by the SIP endpoint using re-INVITE with held/active session descriptions. In an embodiment, the gateway translates this into appropriate H.323 transactions. It uses H.323 V5 section 8.4.6 for this purpose, and it also employs third party call control procedure to put the H.323 leg of the call on hold.

4. In an embodiment, the gateway allows accepting an incoming H.323 call and immediately putting in on Hold. In such situations, it refuses the attempts of the remote H.323 side to resume such call. Similar functionality is provided for incoming SIP calls. This is important to support standard SIP third-party call control procedures.

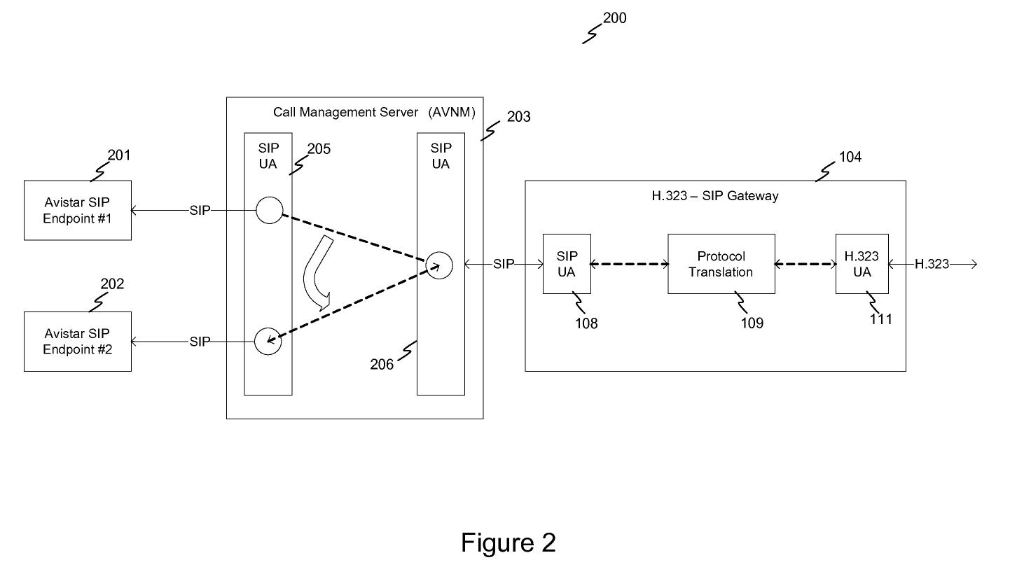

5. As shown in FIG. 2 (200), the SIP Call Management Server may implement 3pcc (third party call control) to enable a SIP endpoint 201 in transferring a call with an external H.323 endpoint, to another SIP endpoint 202. In this scenario, the user agent 205 in the Call Management Server 203 first disassociates the internal-facing and external-facing sides of a call that has been put on hold. It then terminates the original SIP call; and it either places a new outgoing SIP call, or it accepts an incoming SIP call using user agent 206. The gateway does support such 3pcc for call transfers. 6.

Besides 3pcc, the inventive Gateway may also support the SIP REFER request for call transfer.

C. In-Call DTMF Dialing

In an embodiment, the gateway supports in-call DTMF signaling. When in signaling-only mode, it uses SIP INFO messages with appropriate text-based payload; which is translated from/to H.323 “User Input Indication” messages on the H.323 UA (user agent) module of the Gateway on the H.323-facing end. The gateway also supports a separate RTP stream for the DTMF messages. This employs SIP re-INVITEs with appropriate SDP payload and corresponding H.245 logical channel manipulation.

D. In-Call Media Control

There are two widely used methods for requesting video image refreshment. The first method employs the extended RTP Profile for RTCP-based feedback and sending RTCP generic control packets, as described in RFC 4585. The first method is outside the purview of the SIP-H.323 Gateway 104, because it is employed directly between the endpoints. On the other hand, the second method described herein below does involve the SIP-H.323 Gateway. The second method uses application protocol-specific commands, such as the H.245 FastUpdateRequest, which is commonly used by H.323 endpoints to request intra-frames. In an embodiment, this may be supported using SIP INFO messages to translate these requests as described.

This may be achieved by sending SIP INFO methods to the peer, with a SIP message body based on the XML Schema for Media Control as defined in the Internet Draft for XML Schema for Media Control (draft-levin-mmusic-xml-media-control-07). The SIP INFO message body appears as below:

...
Content-Type: application/media_control+xml
Content-Length: 177
...
<?xml version=“1.0” encoding=“utf-8” ?>
<media_control>
<vc_primitive>
<to_encoder>
<picture_fast_update>
</picture_fast_update>
</to_encoder>
</vc_primitive>
</media_control>
...

Ignoring the fast-update requests can result in extreme blockiness and the user-experience would suffer. Specifically, the SIP-H.323 Signaling Gateway translates the H.245 FastUpdateRequest method into a SIP INFO message that carries an intra-frame request, based on the XML Schema for Media Control.

As discussed in the previous section, the gateway may support downspeeding in the midst of a call. It supports requests to reduce the bitrate, initiated by the H.323 endpoint; and it also makes such requests on behalf of the SIP endpoint. Specifically, we honor the H.323 endpoint's requests to close/re-open LogicalChannels. More importantly, we also support the FlowControlCommand when used:
In conjunction with closing/re-opening LogicalChannels as described in Phase D Call services defined in H.323 V5 Section 8.4. (Refer Section 8.4.1 on Bandwidth changes for Downspeeding),
Or in conjunction with H.245 LogicalChannel Bitrate Change messages, or any other H.245 control procedures (as defined in H.245 V9).

Such requests are translated into SIP re-INVITES with modified SDP. In either case, the gateway processes the incoming request from the external H.323 endpoint and relay it to the AVNM using SIP. In an embodiment, it may be important that the logic for generating the response lie on the SIP side; and that the Gateway simply relays the SIP response onto the H.323 side. In an embodiment, the gateway also supports requests initiated by the SIP side, using SIP re-INVITES with modified SDP, and it translates them using the H.323 procedures described above.

In an embodiment, the same mechanism may be used for the conversion of audio-video calls into audio-only calls, and other media-centric call control use cases.

4. Packaging, Environment & Manageability

A. Implementation, Packaging and Environment

In an embodiment, the SIP-H.323 Gateway is supported on Microsoft Windows and on several Linux platforms. The gateway supports SIP and H.323 for call control, as described earlier. In addition, the gateway supports a versioned management API for configuration, security and control. This makes use of XML-RPC over port 80.

B. Support for Debugging and Testing

To facilitate verification and testing, the gateway may provide an optional, simple command-line interface to:
Display the content of state change and event notifications,
Invoke the necessary actions, and
Query current state of API objects and structures.

In an embodiment, the gateway also provides the capability to log usage data and calls.

C. Configuration, Monitoring and Management Support

In an embodiment, the Management API may be designed as a web service, using HTTP and XML, while following XML-RPC syntax. The management interface is kept separate from the call control portion of the SIP-H.323 Gateway. The purpose of this API is to allow configuration and management, to view or edit the state for each connection to an H.323 or SIP endpoint, or infrastructure component.

Some examples of the managed/stateful objects include:

1. Any session involving the gateway, along with session-specific info.

2. The SIP-H.323 Gateway 104 version information.

3. A flag enabling or disabling the connection.

4. The type and friendly name of the network.

5. The maximum number of concurrent SIP and/or H.323 calls.

6. The local address, viz. IP address and port, for SIP.

7. H.323 gatekeeper 105 configuration:

a. Mode (not present, or statically configured),

b. Connection type (we can register as a gateway with a prefix, or as a neighbor gatekeeper or border element, as appropriate),

c. Network address (static, or dynamic)—When statically configured, the TCP port will be specified in the address, or the default of 1719 will be used,

d. Connection state (not connected, discovering, connected, or rejected) and,

Without loss of generality, only one gatekeeper or border element per connection will be configurable.

8. H.323 addressing information: Gateway alias or aliases.

In addition to the above, the usage of implementation-specific shared resources (such as IP ports, etc.) on the host server may be configurable. For example, this may include the following:

1. IP Port for H.225.0 RAS (default=1719, range=1 to 65535).

2. IP Port for H.225.0-Q.931 (default=1720, range=1 to 65535).

3. IP Port Range for H.245 (default range=5555-5574, allowed=1 to 65535).

4. IP Address & Port for SIP.

In an embodiment, the default address of the SIP server may be sip:b2bua@127.0.0.1:5060.

In an embodiment, the default address of the gateway may be sip:gateway@127.0.0.1:6060.

In an embodiment, the logging functionality is also configurable.

Third-party call control, routing and policy-based management of calls between heterogeneous SIP and H.323 endpoints.

Now, advanced features provided by various inventive components will be described in detail, namely the third-party call control and policy-based management of calls between third-party SIP and H.323 endpoints, and with proprietary endpoints. This can be further divided into the following:

1. Proximity-based routing of calls involving combinations of proprietary and standards-based third-party endpoints. This may involve routing calls across IP networks using pre-configured IP ranges. In an embodiment, the routing component would ensure the selection of the optimal gateway from a set of available infrastructure components. It would also ensure the redirection of endpoints to alternate gateways, if dictated by routing policies.

2. Bandwidth management and usage accounting for calls involving combinations of proprietary and standards-based third-party endpoints.

3. Seamless setup and management of calls between proprietary and standards-based third-party endpoints. Advanced call setup features such as transfer, multiparty conferencing, and seamless conversion from/to point calls to/from multiparty calls for standards-based third-party endpoints. In an embodiment, these features may be implemented using third-party call control for combinations of proprietary and standards-based endpoints, wherein the standards-based third-party endpoints would not support these features on their own merit. In an embodiment, infrastructure components would determine capability of the third-party endpoints, and apply third-party call control procedures needed to achieve the desired call setup operation.

1. Incoming SIP Call Support

In an embodiment, the inventive SIP-H.323 signaling-only gateway (also referred to herein as inventive server) caters to requests coming from a SIP endpoint to initiate a session with an external H.323 endpoint. The H.323 URL is supplied in the “To:” header of the SIP INVITE. Addressing options include the H.323 endpoint's IP address, host name, or an H.323 alias string (with or without extensions). The “From:” URL is formatted to indicate caller information to the called H.323 endpoint.

In an embodiment, the gateway accepts the incoming SIP invite, performs the necessary protocol translation and establishes the outgoing H.323 session. It provides the SIP endpoint with a notification regarding the acceptance or refusal of the call by the external H.323 endpoint. It handles errors on the SIP and H.323 side, allows call termination and, it entertains requests to change the state of the call.

For ease of reference and consistency, one may refer to calls placed from SIP endpoints to H.323 endpoints as “outbound” calls.

2. Incoming H.323 Call Support

In an embodiment, the SIP-H.323 Signaling-only Gateway may cater to requests from an external H.323 endpoint to initiate a session with a SIP endpoint. For incoming calls, any address information available in the H.323 call setup messages is retrieved and encoded in SIP “From:” and “To:” headers. In an embodiment, the SIP-H.323 gateway normalizes the incoming address information, as needed for consumption by the SIP infrastructure and endpoints. This is specified in greater detail, in the following discussion. In case all the necessary addressing information isn't available at once during call setup, then the gateway accumulates and updates it over time.

With regards to addressing, the SIP-H.323 Signaling-only Gateway includes the callee's H.323 alias address, specifically, the *dialedDigits* in the user part of the SIP URL. For example, the SIP URL in the “To:” field of the SIP Invite from the SIP-H.323 gateway to the SIP infrastructure could be formatted as:

sip:<N>@<b2bua-address>;user=dialedDigits
where,
<N> is the extension of the SIP endpoint/callee, and
<b2bua-address> is the address of the SIP infrastructure piece.

It should be noted that the URL patterns are customizable, by using a XML-RPC based management API.

In an embodiment, the SIP-H.323 Signaling-only Gateway may accept the incoming H.323 call, performs the necessary protocol translation and establishes the outgoing SIP session. The gateway may provide the SIP endpoint with a notification to allow the acceptance or refusal of the call by the SIP endpoint. This notification includes the calling and called party addresses and a call identifier at the very least. The gateway may handle errors on the SIP side and on the H.323 side, it allows call termination and, it entertains requests to change the state of the call. In an embodiment, the SIP-H.323 Signaling-only Gateway may work with an optional Gatekeeper as outlined in the following discussion.

For ease of reference and consistency, one may refer to calls placed from H.323 endpoints to SIP endpoints as “inbound” calls.

3. Gatekeeper and Direct Inward Dialing (DID)

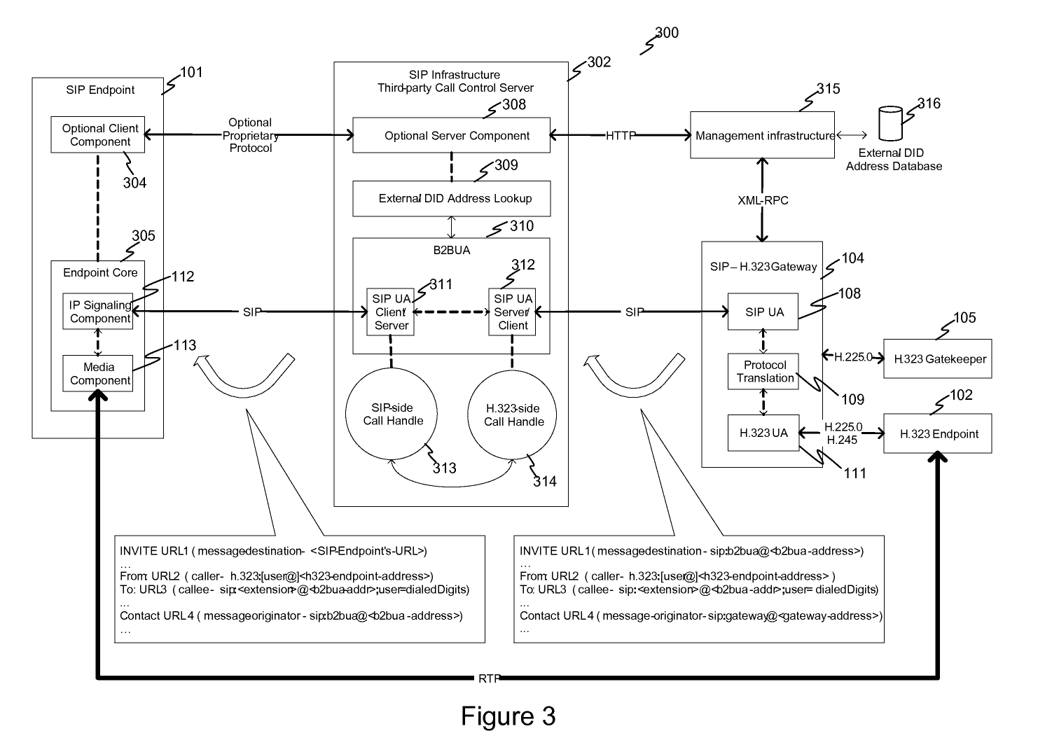

With reference to FIG. 3, embodiments of the SIP-H.323 Gateway 104 can register with the configured Gatekeeper 105 as an H.323 Gateway, using H.323 RAS, on behalf of all the SIP endpoints 101 that it serves. In an embodiment, the gateway's alias is a configurable prefix. In an embodiment, the dialedDigits alias is broken down into the gateway's prefix and the SIP endpoint's extension. In an embodiment, the gateway's management API supports static configuration for the Gatekeeper address; and automatic discovery is also possible. In an embodiment, the SIP-H.323 gateway also supports operation without a Gatekeeper 105. While operating with a Gatekeeper, the gateway augments the incoming call notifications, including calling and called party addresses. Specifically, it reports the Q.931 called party number and H.225.0 destination address, if available.

In an embodiment, the inventive SIP-H.323 gateway may do the following:
It performs the needed minimum validations on the addresses; and
It retrieves relevant parts of the destination address for user lookup, in support of DID/DDI/call-through. This is illustrated in FIG. 3.

The SIP B2BUA & Call Routing

The SIP infrastructure 302 employs a B2BUA entity 310 to host the SIP listener and create a SIP call entity. This SIP call UAC or UAS entity is owned by each of the peer call handles 313 and 314; and ultimately dispatch the SIP session to/from the SIP-H.323 gateway. The SIP signaling protocol is used for call control and communication between the B2BUA and the SIP endpoint 101 on one side; and the SIP-H.323 Signaling Gateway 104, on the other side.

With reference to the FIG. 3, the SIP infrastructure is represented as a B2BUA entity 310, which has a scope that spans several SIP sessions in time; and is shared by several sessions at any given instance as well. This architecture allows for third-party call control. Further, the peer call handles 313 and 314 own their respective peer B2BUA SIP call objects: UA Client 311 and UA Server 312. These SIP call objects are complementary in the context and scope of a SIP transaction, as defined in RFC 3261, well known to persons of skill in the art. Specifically, if one acts as a SIP Server, then the peer acts as a SIP Client for the life of that SIP transaction. Of course, the client/server roles can change in the context of the parent SIP session/call.

In an embodiment, the SIP call object on the H.323-facing side talks to the SIP-H.323 gateway. Likewise, the SIP call object on the SIP-facing side will talk to the SIP endpoint; or to another gateway, or infrastructure component. In parallel, the call handle that owns the SIP-facing SIP call object may optionally use the third-party call control server component 308 to employ another proprietary or standard protocol to communicate with the SIP endpoint. The SIP infrastructure may also integrate with a user database 309, for looking up the callee and the corresponding SIP endpoint. This allows automatic routing of the call to the SIP endpoint, aka DID.

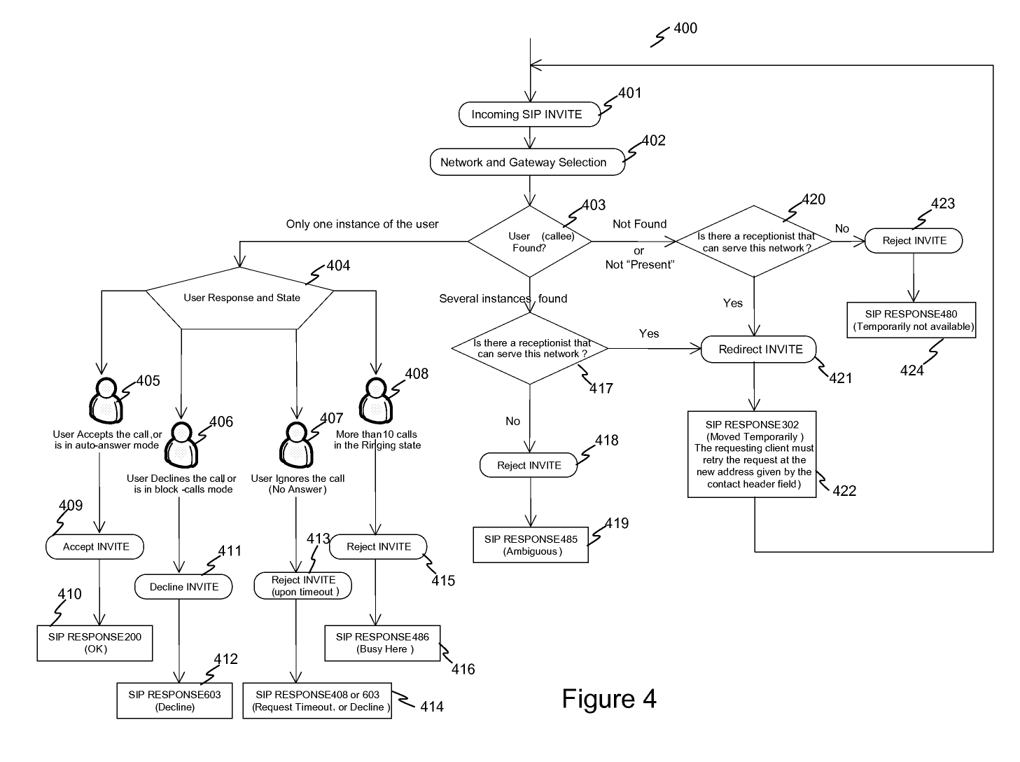

In an embodiment, the SIP users' H.323 addresses for DID are advertised by the user management infrastructure 315. This allows the assignment of gateways to SIP B2BUA servers, assignment of prefixes to gateways, and extensions to SIP users. In this way, it is possible for every SIP endpoint to have its own unique H.323 address for direct dialing. If the H.323 address for the user has not been configured, it is be assigned automatically and maintained by the SIP infrastructure to ensure uniqueness. The gateways prefixes and user extensions are propagated across the SIP infrastructure. With reference to FIG. 4 illustrating method 400, the “dialedDigits” from the “To:” header of the incoming SIP INVITE 401 will be the key for searching the user database 316. The dialed digits are a concatenation of the gateway prefix and the SIP user's extension. If no SIP user with a matching H.323 address is found at 403, then the border SIP B2BUA server will route the call to the receptionist for that network (417). If the user is found, then its network will serve as the destination video network for the routing module. If the receptionist is not found, the invite is rejected (418, 423) and the SIP response is sent (419, 424).

In an embodiment, if the user lookup does not return a match, or if it returns multiple matches, then the call will be routed to the Receptionist for the selected network (417, 420 and 421), or the default network, as appropriate. If the callee is in “blocked calls” mode (404, 406), or if they have reached their limit (404, 408) for the maximum number of active calls, then a message indicating that the user is not available is sent back to H.323 endpoint (411, 412, 415 and 416).

In an embodiment, if the user accepts the call or in auto answering mode (405), the invitation is accepted (409) and SIP response 410 is send. Finally, if the user ignores the call (407) invitation is rejected (413) and SIP response is sent (414).

In an embodiment, the SIP server uses specific response codes, when sending a response to the gateway. These are listed below, and they are translated by the gateway, into appropriate H.323 reason codes.
Provisional 1xx
Successful 2xx
Redirection 3xx
Request Failure 4xx
Server Failure 5xx
Global Failures 6xx

Specific and discrete request failure (4xx) or server failure (5xx) or global failure (6xx) codes will be used to convey user actions and endpoint/system events and states, as appropriate. FIG. 4 illustrates the INVITE processing for DID, and the relevant response codes.

Network Management: Routing & Bandwidth Accounting

In an embodiment, a SIP-based network management infrastructure allows the dynamic creation of video ports on the video network for the SIP and H.323 endpoints. The video network represents a resource pool used for bandwidth accounting. The video ports represent an instance of an endpoint's access to this resource pool. The video networks are also configured to represent the IP network topology. With pre-routing for outgoing calls; and with gateway-redirection for inbound calls, our routing functionality ensures optimum resource allocation. Both pre-routing and gateway-redirection are explained hereinbelow.

An enterprise may have multiple connections to the internet, and to other networks. Bandwidth accounting benefits from the ability to route calls to the appropriate “destination” video network (terminal node). Managed video networks and bandwidth management is one of the unique features allowed by our SIP infrastructure and the SIP-H.323 Signaling-only Gateway.

As a use case and an example, consider the case where a SIP endpoint on the “Northern California” managed video network calls a H.323 endpoint on the “London” managed video network. Both the video networks are managed by an instance of our SIP infrastructure. Each instance, in turn is enabled with an instance of the SIP-H.323 signaling-only gateway. If we are to choose the nearest network, or option #1 (521) for pre-routing as described in the decision tree in the following section, then we will end-up accounting the usage of bandwidth by the H.323 endpoint against the “Northern California” video network. Ideally, we would have liked it to use the “London” video network and account the bandwidth against a configurable trunk between the two networks.

The above discussion advocates the value in considering options for Pre-Routing based on the callee's information (504) (and not the caller's information). In an exemplary embodiment, then, the, infrastructure may preferably to behave as follows:

1. Implement Pre-Routing using the callee's information 504, which maps onto options #3 512 and #4 506, as highlighted in decision tree, in the following section. Pre-routing is based on IP Range configuration and IP address of the external H.323 endpoint.

2. The SIP infrastructure imposes online IP Address lookup functionality on the SIP-H.323 gateway. In an embodiment, this is accomplished by the SIP-H.323 gateway and may be enabled using the SIP OPTIONS method.

3. In an embodiment, the SIP infrastructure allows IP address range configuration; and falls-back to option #1 for pre-routing, in the event that the destination video network cannot be resolved by the above.

4. In an embodiment, a call is rejected when the SIP-H.323 gateway capacity has been exceeded (in terms of the number of concurrent calls). In an embodiment, the call is not re-routed to another destination video network so as to prevent resulting poor usage of bandwidth.

In an embodiment, for inbound calls, bandwidth accounting may depend on the selection of the “source” video network (leading node) or the SIP-H.323 gateway used for the call. To summarize, the Pre-Routing for outbound calls must be based on callee information, while SIP-H.323 gateway selection for inbound calls must be based on caller information. In general, for accuracy in the bandwidth accounting and usage, the gateway selection 402 may be based on the proximity to the H.323 endpoint, while allowing the SIP infrastructure to do the bandwidth management on the SIP leg of the call. Gateway selection and redirection is discussed further in a later section of this document.

6. Outbound Call Pre-Routing

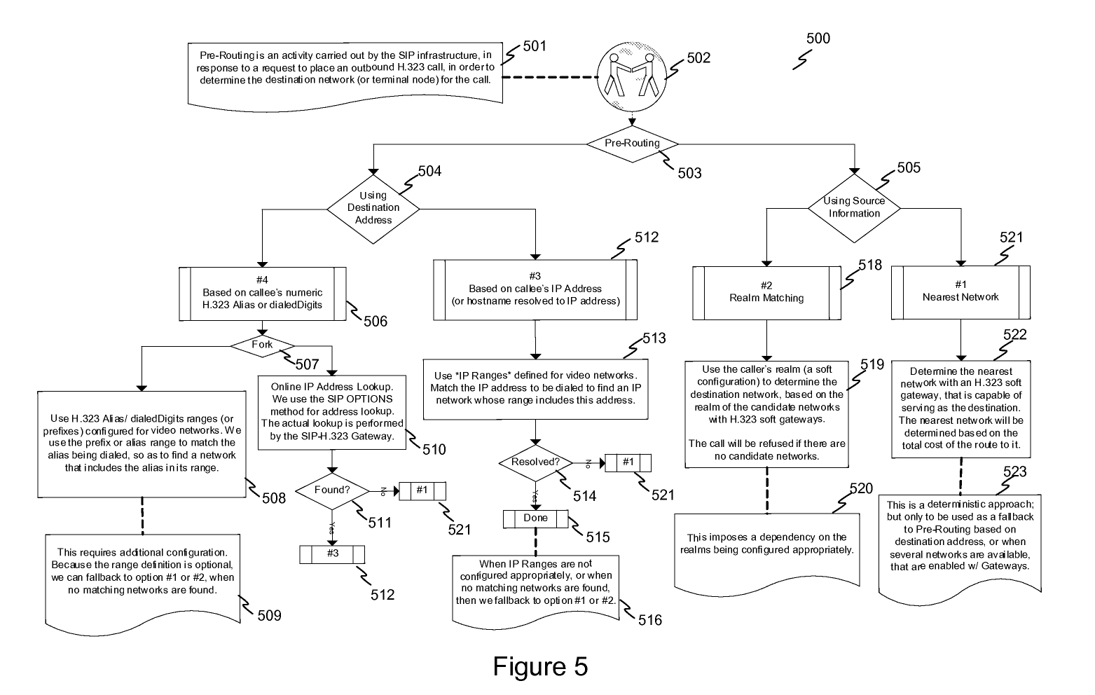

The H.323 destination addresses provided by the SIP endpoint user includes the H.323 callee's IP Address or the H.323 alias. In an embodiment, the SIP infrastructure maps this onto a video network as part of the Pre-Routing process. FIG. 5 (steps 501-523) illustrates the Pre-Routing decision tree 500.

In an embodiment, the determination of the destination video network or terminal node for routing is primarily the responsibility of the SIP infrastructure. The SIP The SIP infrastructure is already aware of the network topology on the SIP side and the SIP endpoints' IP addresses. The SIP infrastructure relies on the SIP-H.323 gateway to provide the H.323 endpoint's IP address. Based on the information provided by the gateway; and based on the configuration, the SIP infrastructure uses the combination of callee's IP address and alias and/or caller's location or realm information to perform Pre-Routing.

7. Endpoint IP Address Lookup

In an embodiment, the SIP infrastructure, B2BUA or third-party call control server may request the SIP-H.323 gateway to resolve an H.323 alias into the IP address for the H.323 endpoint. It will use the SIP OPTIONS method for this purpose. In an embodiment, the actual lookup will be performed by the SIP-H.323 gateway; and the gateway will consult the H.323 Gatekeeper, as appropriate.

In an embodiment, the SIP-H.323 gateway will always provide the external H.323 endpoint's IP address for inbound calls to SIP endpoints. This information will be included as part of the addressing information in the SIP INVITE from the SIP-H.323 gateway to the SIP infrastructure. The SIP infrastructure will use this information for routing, optimum network/resource pool allocation and for bandwidth usage accounting in calls. Based on the address of the H.323 endpoint, the SIP infrastructure could redirect it to another SIP-H.323 gateway if that is more suitable for purposes of optimum network/resource pool allocation and for bandwidth usage accounting.

8. Bandwidth Accounting for Inbound Calls

Attention is now directed to bandwidth accounting for inbound H.323 to SIP calls. We take the same use case employed earlier, wherein we have a SIP endpoint on the “Northern California” video network, which, this time around, receives an incoming call from a H.323 endpoint near the “London” video network. At least one of the two video networks is enabled with a SIP-H.323 gateway. If the two networks are both enabled with their own separate gateways; and if the SIP endpoint in northern California advertises its H.323 address to use the northern Californian gateway's prefix, then the northern Californian gateway may get used in the call. And we could end-up accounting the usage of bandwidth against the “Northern California” video network.

In an embodiment, ideally we would have liked to use the “London” video network and account the bandwidth against the trunk between the two networks. One way to make this happen is by changing the H.323 user address scheme for SIP endpoints, to allow selection of the gateway in London. In general, the gateway selection should be biased towards the gateway that is closer to the H.323 endpoint. Let's look at ways of achieving this, without changing the SIP user's addressing scheme.

Just as Pre-Routing for outbound calls must be based on callee information, the Gateway selection for inbound calls must be based on caller information. In general, for accuracy in the bandwidth accounting, the gateway selection must be based on the proximity to the H.323 endpoint; and not the SIP endpoint. This is because the SIP endpoints are already managed and their topology represented by the SIP infrastructure.

Accordingly, two architectural recommendations for bandwidth accounting may be made. While recommendation #1 will always be used for the originating video network selection, recommendation #2 may be used as an additional precursor. Specifically, the latter addresses gateway selection and the SIP user address scheme.

Recommendation #1: Video Network Selection

i. The SIP-H.323 gateway will always provide the H.323 endpoint caller's IP address.

ii. The SIP infrastructure will use its IP Range configuration to determine the originating video network. In case of insufficient IP Range configuration, the originating Video Network will be the default video network, designated for calls with H.323 endpoints.

Recommendation #2: Gateway Selection and Redirection

So far, we have identified three possible options:

Option #1: Gateway Prefix based Gateway Selection:

i. The Gateway has a 1:1 relationship with the SIP infrastructure.

ii. We use configurable Gateway Prefix(es) in the SIP endpoint's advertised H.323 user address. Calls to SIP users will have the H.323 alias begin with the gateway prefix.

iii. Gateway Selection to be based on the gateway prefix dialed by the H.323 endpoint caller.

Option #1+: Gateway Redirection:

In order to ensure the best possible bandwidth accounting, the SIP infrastructure (or B2BUA) may implement a mechanism, to redirect the inbound call from an H.323 endpoint to another pair of SIP infrastructure and gateway. This will be accomplished using the following steps:

i. The gateway receives an incoming H.323 call and translates it into a SIP INVITE directed to the SIP server. It provides the IP address of the H.323 endpoint.

ii. The SIP server looks at topological information, specifically enterprise-wide IP Range configuration, to determine the best video network hosted by any of the SIP servers in the enterprise. From the video network, it determines the SIP server and ultimately the gateway that is most suitable for the call. If this is not the gateway that sent the INVITE, then the SIP server refuses the SIP INVITE with a request to redirect the call to another destination. As part of responding to the gateway's INVITE in such a manner, the SIP server specifies the address information of the destination gateway for redirection.

iii. The gateway intercepts the SIP server's redirection 3xx response (usually 302); and in turn, it responds to the H.323 caller with the addressing information. Please refer to the section on Gateway Redirection for specific H.323 mechanisms for forwarding/redirecting a call. Our implementation for H.323 call redirection prefers the usage of the H.225.0 Facility message.

To make this easy to manage and effective, we provide the following unique features:
Configuration support to enable or disable Gateway Redirection (enabled by default)
Propagation of network configuration and gateway addresses between SIP servers
SIP and H.323 redirection support in the SIP server
Redirection support in the SIP-H.323 gateway

Option #2: H.323 neighbor Gatekeeper based Gateway Selection:

i. The gateway has a 1:1 relationship with the SIP server.

ii. In an embodiment, a configurable global/deployment-level prefix in the SIP endpoint's advertised H.323 user address may be used. Calls to SIP users will have the H.323 alias begin with the global prefix.

iii. In an embodiment, the H.323 neighbor Gatekeeper may be implemented as part of a SIP-H.323 gateway solution. The neighbor Gatekeeper registers with the enterprise's external H.323 Gatekeeper for address resolution upon calls to SIP endpoints.

iv. In an embodiment, only one H.323 neighbor Gatekeeper may be allowed per deployment. It bears a 1: n relationship with SIP-H.323 gateways; and it would be aware of the respective SIP servers' IP Range configurations. The neighbor Gatekeeper then provides the needed resolution for Gateway Selection, based on Gateway's proximity to the caller (which, in this case is the H.323 endpoint).

Option #3: Single Gateway per deployment:

i. This option would enforce one SIP-H.323 gateway per deployment/enterprise, and it will have a 1: n relationship with the SIP servers. (Each server may in turn manage multiple video networks).

ii. We use a configurable prefix in the SIP endpoint's advertised H.323 user address. Calls to SIP users will have the H.323 alias begin with this prefix.

iii. The gateway will be aware of the SIP servers' IP Range configurations.

iv. In an embodiment, the SIP-H.323 gateway will implement a gateway manager, which will be used for central configuration purposes.

In an embodiment, the Gateway Selection follows:
recommendation #1 for network selection; and
recommendation #2, options 1 & 1+ for gateway selection & redirection.

In an embodiment, the system and method allows for the usage of recommendation #2, options 2 and 3, as needed for a deployment. Option 2 is recommended for larger deployments, while option 3 is only suitable for small deployments.

9. Gateway Redirection

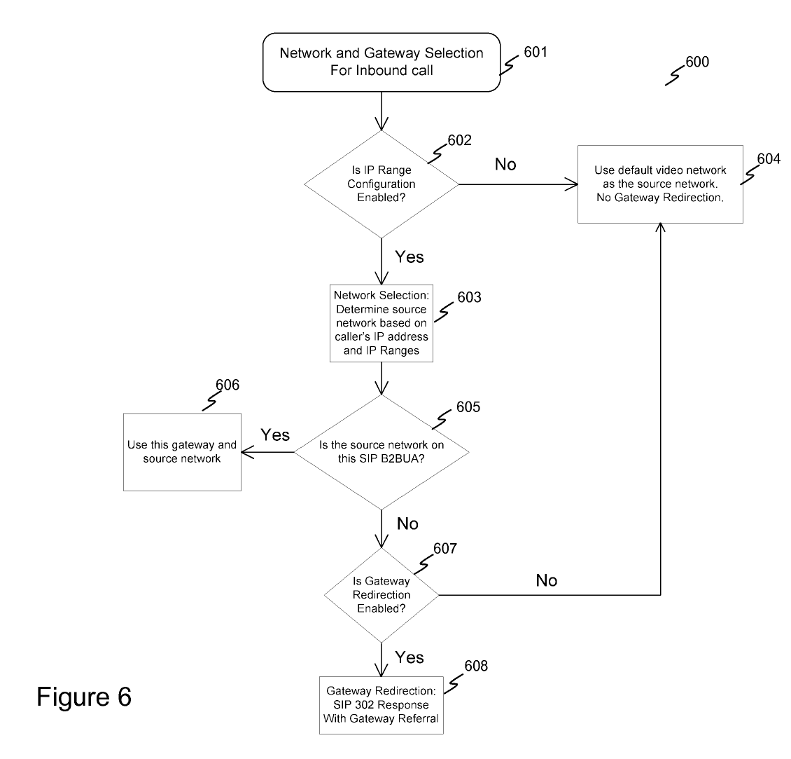

In order to ensure the best possible bandwidth accounting and resource allocation, the SIP infrastructure (or B2BUA) and the SIP-H.323 gateway may implement a mechanism, to redirect the inbound call from an external H.323 endpoint to another instance of the SIP-H.323 gateway deployed elsewhere. This is accomplished by using the steps 601-608, illustrated in FIG. 6:

1. The SIP-H.323 gateway receives an incoming H.323 call and translates it into a SIP INVITE directed to the SIP infrastructure. It provides the IP address of the H.323 endpoint in the “From:” field of the INVITE (step 601).

2. The SIP infrastructure looks at topological information, specifically enterprise-wide IP Range configuration (602), to determine the best network or bandwidth pool to host the external endpoint on. From the network, it determines the B2BUA and ultimately the SIP-H.323 gateway instance that is most suitable for the call. If this is not the SIP-H.323 gateway instance that sent the INVITE, then the SIP infrastructure refuses the SIP INVITE with a request to redirect the H.323 call to another H.323 destination. As part of responding to the SIP-H.323 gateway INVITE in such a manner, the SIP infrastructure may specify the H.323 destination as the H.323 address of the appropriate SIP-H.323 gateway instance, more suited for the call.

3. In an embodiment, the SIP-H.323 gateway intercepts the SIP infrastructure's redirection 3xx response (usually 302); and in turn, it responds to the external H.323 caller with the addressing information in a Facility message.

In an embodiment, the H.323 Call Redirection may be implemented using the Facility Message from the H.225.0 specification. While this may be a preferred approach, the invention also provides for the support other methods as allowed by the endpoints. In an embodiment, the user-to-user information element (UUIE) of the facility message is used primarily for call redirection. The UUIE contains a field, facilityReason, which indicates the nature of the redirection. In an embodiment, the reason could be routeCallToGatekeeper or callForwarded. Various exemplary H.323 methods are described below:

H.225.0 Specification: Facility Message (Typically Preferred Implementation)

In order to signal call redirection specific to H.323 procedures (call forwarding, redirecting a call to the MC, or forcing a call to be routed to the gatekeeper) or in case of supplementary service signaling according to ITU-T H.450, the User-user information element of the Facility message is used. In order to indicate call forwarding, the Facility IE shall be empty and the Facility-UUIE shall indicate in the alternativeAddress or the alternativeAliasAddress the terminal to which the call is to be redirected. In this case, the facilityReason shall be set to callForwarded.

Call Forward

In certain cases, an H.323 endpoint might determine that a call needs to be forwarded. The endpoint could then send a facility message with a facilityReason of callForwarded. This message includes the address of the new destination (either an alternativeAddress or alternativeAliasAddress). In an embodiment, upon receiving the facility message, the peer source endpoint sends a release complete message to the original destination endpoint and initiates a new call using the new destination address supplied in the facility message. The release complete message could contain a ReleaseCompleteReason of facilityCallDeflection.

Supplementary H.450.3 Call Deflection

Call deflection is a feature under H.450.3 Call Diversion (Call Forwarding) that allows a called H.323 endpoint to redirect the unanswered call to another H.323 endpoint.

10. Third-Party Call Control

The third-party call control allows for the following:
Putting an endpoint on hold, or resuming it. This is done by employing re-INVITEs on the SIP side and translating them to logical channel manipulation on the H.323 side.
Transfer from one endpoint to another, or to a recording agent, for applications such as voice mail, by using REFER on the SIP side, or using 3pcc, by putting the SIP side on hold, and swapping the SIP UA.
Multiparty call setup and collapse, by transferring a H.323 endpoint to a SIP Focus conferencing server.

(It is noted that a description of third-party call control procedures has been provided earlier.)

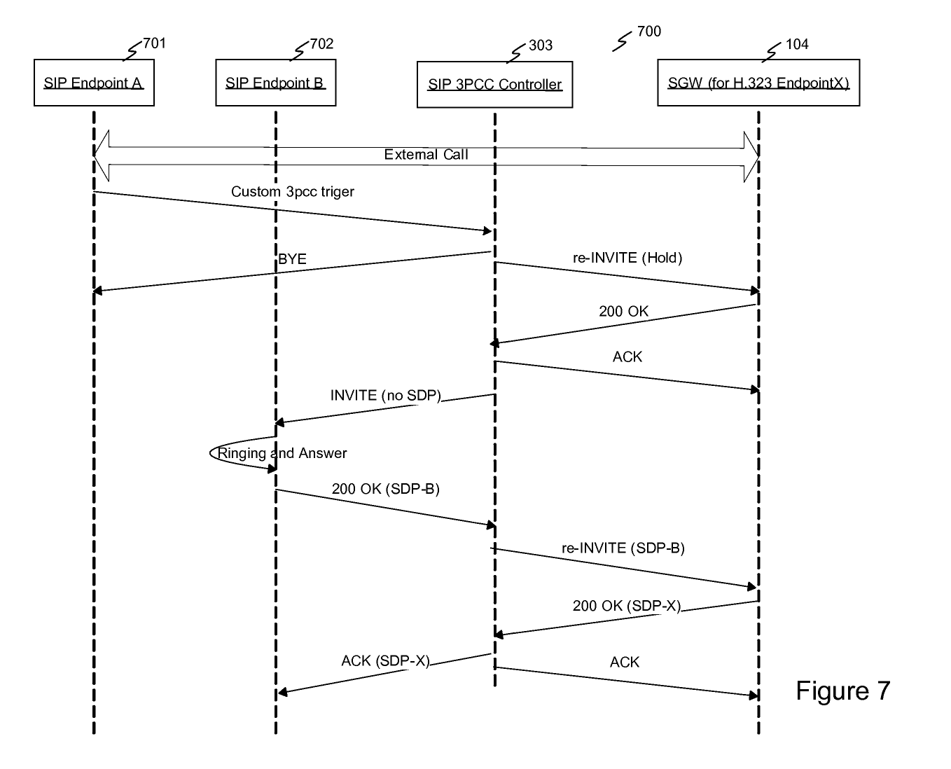

The exemplary sequence diagram shown in FIG. 7 illustrates the procedure 700 for transferring an H.323 endpoint (X) from one SIP endpoint (A) 701 to another (B) 702.

11. Handling Provisional Responses

As part of handling an inbound call, the SIP-H.323 gateway may direct its SIP UA in sending an outgoing INVITE request to the configured SIP B2BUA. When the gateway receives a provisional (1xx) response to its INVITE, it starts or resets its transaction timer, viz. the completionTimer. When this timer goes off the SIP transaction is terminated. The interval used to control the completionTimer depends on the type of the transaction, and it could be one of the following two values:
InviteTimeout: is used for INVITE transactions. The default is 32 seconds.
NonInviteTimeout: for all other methods. The default value is 16 seconds.

These values are only used by the completionTimer, and changing them does not influence anything else. These time intervals can be configured and queried, by using the following XML-RPC:

sgwApiV1.setSipInviteTimeout <time-interval-in-milliseconds>
sgwApiV1.querySipInviteTimeout
sgwApiV1.setSipNonInviteTimeout <time-interval-in-milliseconds>
sgwApiV1.querySipNonInviteTimeout

The gateway supports “transparent” inbound call transfer, where a SIP proxy forwards the INVITE to a voicemail server on its own and sends a provisional 181 response to the gateway, as per the section 6.1 of RFC 4458. The handling of provisional responses is described above.

12. Inbound Call Redirection

In an embodiment, the SIP-H.323 gateway supports redirection, triggered by a 3xx response to an outgoing INVITE for an inbound call. Specifically, it supports two types of redirection: the end-to-end H323 redirection and the SIP-side redirection. The type of call redirection is determined by the parameters to the SIP URI that is used to specify the alternate address, in the “Contact:” header field of the response.

A. SIP-Side Redirection

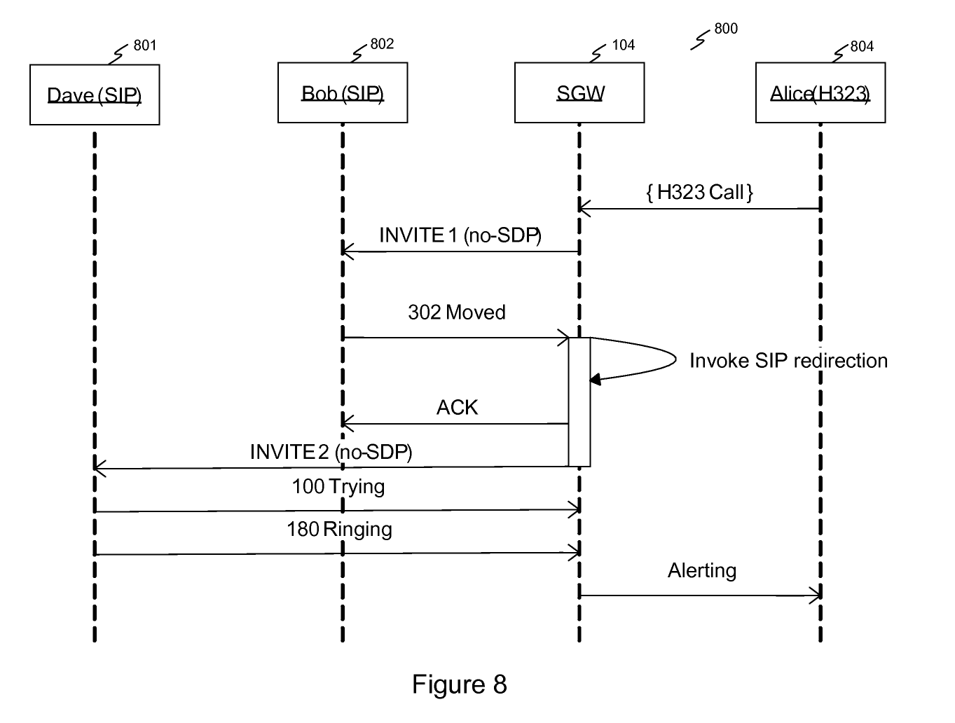

In an embodiment, the SIP-H.323 gateway supports SIP redirection, as per the section 6.2 of RFC 4458. The message flow diagram 800 illustrated in FIG. 8 shows an example of a SIP-side call redirection, where the H.323 leg of the call is left intact, while the SIP-peer is switched. Here, an H.323 endpoint—Alice 804 calls a SIP endpoint—Bob 802. Bob 802 is busy, but he decides to forward the session to another SIP endpoint—Dave 801, by sending a 302 response to the gateway with Dave's address.

In an embodiment, the SIP-H.323 gateway keeps the H.323 side of the call intact, while re-issuing the initial outgoing INVITE on the SIP side to the new destination (Dave). Unlike the end-to-end H.323 redirection, the gateway remains involved in the call, subsequent to redirection.

B. End-to-End H323 Redirection

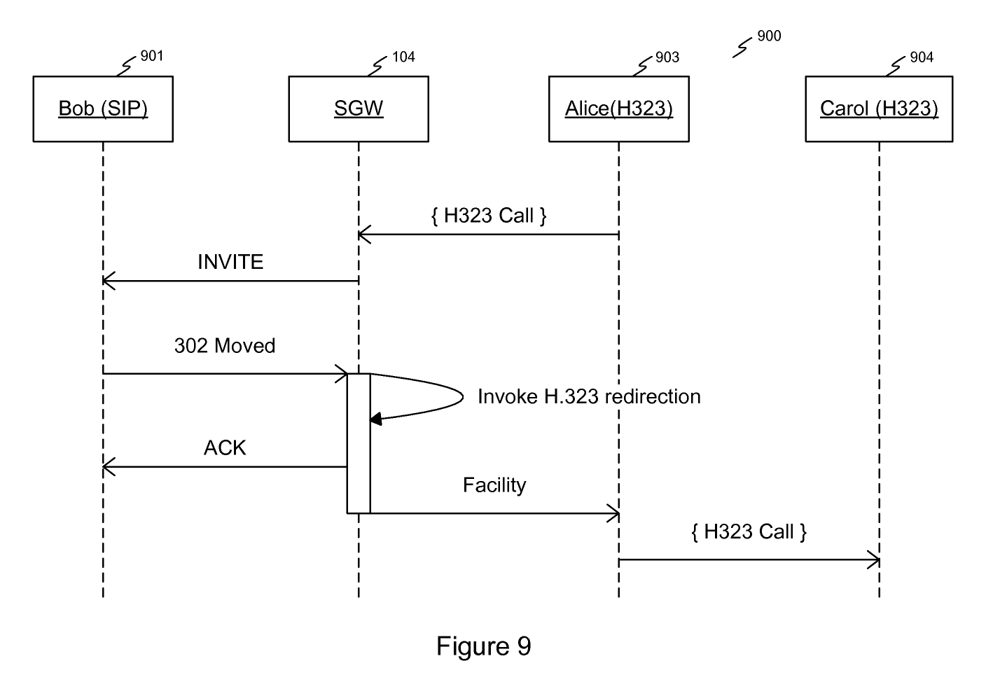

The message flow shown in the diagram presented in FIG. 9 illustrates an exemplary end-to-end H.323 call redirection 900. The call was originally placed from an H323 endpoint—Alice 903, through the SIP-H.323 gateway 104, to a SIP endpoint—Bob 901. This call was redirected by Bob 901, who passes an alternate H.323 address to the gateway in the 302 response. The gateway intercepts this, and it sends a Facility message to Alice 903, with this alternate H.323 address. This results in the automatic placement of a call from Alice to Carol 904, who is at the alternate H323 address.

In this case, the Contact header of the 302 response message will have the addressing information required to redirect the incoming H.323 call to another H.323 endpoint, MCU, or Gateway. The H.323 addressing information is encoded by appending the following parameters to the SIP URI, in the “Contact:” header field:
alternate-host: IP address of H.323 endpoint,
alternate-port: port number of the H.323 endpoint,
alternate-alias: the alias of the H.323 endpoint, to which the call is being redirected.

As shown in the above call flow, neither Bob, nor the gateway is involved in the call, subsequent to redirection.

The SIP URI in the “Contact:” header field must follow this syntax: sip:<sgw-sip-user>@<sgw-hostport>;<h323-address-info> where the <h323-address-info> could be one of the following:

~ alternate-alias={alias}, or
~ alternate-host={host}[;alternate-port={port}], or
~ alternate-alias={alias};alternate-host={host}[;alternate-port={port}]

If neither keyword, viz. neither alternate-alias nor alternate-host are present in the SIP URI, then the gateway will attempt to invoke the SIP-side call redirection, which is described in the next section.

An example of the 302 response message is shown below.

SIP/2.0 302 Recipient has moved temporarily, new URL available
CSeq: 1 INVITE
Via: SIP/2.0/UDP 172.16.11.12:6060;\

branch=c76d00b2-ecf9-1810-83af 00123f72970e

User-Agent: avnm/10.0.2.27
From: “Alice” <h323:6542@172.16.11.213:3232;transport=udp>;\

tag=c76d00b2-ecf9-1810-83ae-00123f72970e

Call-ID: 892400b2-ecf9-1810-83ae-00123f72970e@host
To: <sip:333@172.16.11.74:5063;user=dialedDigits>;tag=030214da4461
Contact: <sip:SGW_UA@172.16.11.12:6060;\

alternate-host=172.16.12.202;alternate-alias=123>

Allow: INVITE, CANCEL, BYE, ACK, INFO

Dial Patterns Used in Inbound (H.323 to SIP) Calls

An embodiment of the inventive concept provides native support for SIP, H.323 and proprietary signaling protocols, in a network and call management infrastructure. An embodiment of the invention is implemented using inventive SIP-H.323 Signaling-only Gateway and a third party call control server.

Inbound Dial Patterns

In an embodiment, the inventive server provides a configuration (sgw.ini) parameter, viz. SIP_InboundDialPattern, to specify how the destination/callee SIP address will be conveyed in the “To:” field of an outgoing SIP INVITE for a H.323 to SIP inbound call. This is also used for conveying the H.323 endpoint's addressing information in the “From:” field of the outgoing INVITE.

Registration Prefix and Extension

In an embodiment, the inventive server registers with a Gatekeeper, as a Gateway, and it uses its registration prefix while doing so. For inbound calls in gatekeeper-managed environments, the inventive server only passes the extension to the SIP side. The extension is simply the dialedDigits alias, without the gateway's registration prefix. Stripping-off the registration prefix is not applicable to unmanaged environments.

SIP B2BUA

In an embodiment, the inventive server will transmit the outgoing SIP INVITE for the inbound call to the address configured in the SIP_B2bUaUrl from sgw.ini parameter, or to the B2BUA configured by using the XML-RPC API. While this parameter typically points to a SIP B2BUA, or to a SIP 3pcc infrastructure component in production, one could also specify the address of a SIP endpoint for purposes of testing with standalone endpoints.

Supported SIP Inbound Dial Patterns

1. SIP URI

To: sip:{to-user-part}@{b2bua-address}; user=dialed Digits

From: sip: {from-user-part} @{sgw-address}

| | | Required |
|---|---|---|
| Name | Description | field |
| to-user-part | extension, which the dialedDigits alias, | Yes |
| | after stripping off the gateway prefix, or | |
| | a fixed string when an extension is not | |
| | available, viz. “receptionist” | |
| b2bua-address | The address of the SIP B2BUA, as | Yes |
| | configured using the XML-RPC API, | |
| | or in the SIP_B2bUaUrI configuration | |
| | parameter. | |
| user=dialedDigits | This parameter will be appended to the | No |
| | URI in the “To:” field, if the | |
| | configuration parameter | |
| | SIP_DialedDigitEnable is set to True. | |
| from-user-part | h323-alias, or | Yes |
| | h323host={h323host}, or | |
| | h323-alias;h323host={h323host} | |
| sgw-address | Host-port of Inventive server. | Yes |

To enable this dial pattern, the following configuration (sgw.ini) parameter should be set:

SIP_InboundDialPattern=1

Or, one can also use the XML-RPC API sgwApiV1.SetInboundDialPattern to set the inbound dial pattern.

2. H.323 URI

To: h323:[extension]@{b2bua-address}

From: h323: {h323-address}

| | | Required |
|---|---|---|
| Name | Description | field |
| extension | The dialedDigits alias, after stripping | No |
| | off the gateway prefix. | |
| b2bua-address | The address of the SIP B2BUA, as | Yes |
| | configured using the XML-RPC API, or | |
| | in the SIP_B2bUaUrI configuration | |
| | parameter. | |
| h323-address | The H.323 caller endpoint's host, or | Yes |
| | the H.323 caller's dialedDigits alias, or | |
| | Both. | |

To enable this dial pattern, the following configuration (sgw.ini) parameter should be set:

SIP_InboundDialPattern=2

Or, one can also use the XML-RPC API sgwApiV1.SetInboundDialPattern to set the inbound dial pattern.

This is also the default value.

3. TEL URI

To: tel:{tel-uri-prefix}[extension]

From: tel:{tel-uri-prefix} [e164-alias]

| | | Required |
|---|---|---|
| Name | Description | field |
| tel-uri- | We introduce a new parameter, called | Yes |
| prefix | SIP_TelUriPrefix, which will be used to prefix | |
| | the “tel:” URI. The default value would be “+1-”. | |
| | This will be useful for cases where we need to | |
| | relay the address as a “tel:” URI, in unmanaged | |
| | environments, where we don't have an | |
| | extension for the endpoint. | |
| extension | The dialedDigits alias, without the gateway | No |
| | prefix. | |
| e164-alias | The H.323 caller's dialedDigits alias. | No |

Some rules with regards to the “tel:” URI prefix:

1. In addition to digits, we allow ‘+’ and ‘−’ characters, in the “tel:” URI prefix.

The ‘+’ is only allowed as the first character in the prefix.

The ‘−’ must follow a digit.

The “tel:” URI prefix must contain at least one digit.

2. We do not automatically insert any ‘+’ and ‘−’ characters, unless they are explicitly present in the “tel:” URI prefix.

3. When we receive an absolute E.164 address that begins with a ‘+’, then we pass it as is. In such cases, we do not strip the registration prefix, and we do not pre-pend the “tel:” URI prefix. In all other cases:

we first strip the registration prefix (if it is present in the dialedDigits), and

we then pre-pend the “tel:” URI prefix.

To enable this dial pattern, the following configuration (sgw.ini) parameter must be set:

SIP_InboundDialPattern=3

Or, one can also use the XML-RPC API sgwApiV1.setInboundDialPattern to set the inbound dial pattern. Finally, one can also use the XML-RPC API-sgwApiV1.setTelUriPrefix to set the “tel:” URI prefix.

Examples illustrating the usage of Dial Patterns in inbound calls

The following table shows an exemplary mapping between the “To:” field in the SIP INVITE, and the H.323 address or string, as dialed at the H.323 endpoint.

In these examples, the H.323 caller's IP address is 74.125.45.1 and alias is “456”.

The SIP-H.323 gateway IP address is 74.125.45.2, SIP port is 6060, and its “tel:” URI prefix is “+1−”.

Finally, the IP address of the SIP B2BUA is 74.125.45.3; and the SIP callee's extension is “23”.

The Inventive server is registered with a Gatekeeper, and its registration prefix is “1”, in all of the examples.

| Pattern | Dial string at e/p | “To:” field in the SIP INVITE | “From:” field in the SIP INVITE |
|---|---|---|---|
| 1 | 74.125.45.2##123 | sip:23@74.125.45.3 | sip:456;h323host=74.125.45.1 |
| | | | @74.125.45.2:6060 |
| | 74.125.45.2 | sip:receptionist@74.125.45.3 | sip:456;h323host=74.125.45.1 |
| | | | @74.125.45.2:6060 |
| | 123 | sip:23@74.125.45.3 | sip:456@74.125.45.2:6060 |
| 2 | 74.125.45.2##123 | h323:23@74.125.45.3 | h323:456@74.125.45.1 |
| | 74.125.45.2 | h323:@74.125.45.3 | h323:456@74.125.45.1 |
| | 123 | h323:23 | h323:456 |
| 3 | 74.125.45.2##123 | tel:+1-23 | tel:+1-456 |
| | 74.125.45.2 | tel:+1 | tel:+1-456 |
| | 123 | tel:+1-23 | tel:+1-456 |

Note:

The addition of the prefix by the caller, and the stripping-off of the prefix by the SGW; only applies to GK-managed environments. A string dialed as “74.125.45.2##1” will result in the dialedDigits alias of “1” passed in the “To:” field of the outgoing SIP INVITE for the inbound call, in an unmanaged environment.

Dial Patterns Used in Outbound (SIP to H.323) Calls

Outbound Dial Patterns

In an embodiment, the inventive server supports a variety of patterns that can be used by its peer SIP UA/B2BUA, to convey the destination H.323 address, in the “To” header or “Request-URI” of a SIP INVITE sent to the SIP-H.323 gateway server, for a SIP to H.323 outbound call.

Based on the syntax and rules of the outbound dial patterns, the SIP-H.323 gateway server will parse the “To” header or “Request-URI” of the incoming SIP INVITE, in order to gather the H.323 callee's information.

In an embodiment, the inventive server supports all patterns. Users are free to use (or not use) any specific patterns in a particular deployment, without needing specific configuration for this. The target for parsing out the H.323 destination information is configurable though, as described at the end of this document, just before the section on examples.

Supported SIP Outbound Dial Patterns

1. Encoding the destination H.323 address in the user-part of the SIP URI

sip:{h323user}[;h323host={h323host}[;h323port={h323port}]]@{sgw-hostport}

| | | Required |
|---|---|---|
| Name | Description | field |
| h323user | H.323 user. | Yes. |
| | 1*(%x21-24 / %x26-3F / %x41-7F / escaped) | |
| | (Please refer to RFC 3508 for formal syntax | |
| | definition.) | |
| h323host | H.323 host. | No. |
| | hostname / IPv4address | |
| | (Please refer to RFC 3508 for formal syntax | |
| | definition.) | |
| h323port | H.323 port. | No. |
| | 1*DIGIT | |
| | If not specified, a default value of 1720 is | |
| | assumed. (Please refer to RFC 3508 for formal | |
| | syntax definition.) | |
| sgw- | SIP-H.323 gateway server host and port. | Yes. |
| hostport | host[“:”port] | |
| | (Please refer to RFC 3261 for formal syntax | |
| | definition.) | |

In an embodiment, this dial pattern is employed when the SIP-H.323 gateway receives an incoming INVITE where the “To” header or “Request-URI” contains the callee information provided as a SIP URI: sip:{user}@{sgw-hostport}, where the user part may be expanded as {h323user}[;h323host={h323host}[;h323port={h323port}]].

In an embodiment, the SIP-H.323 gateway may use the user, host and port information to form a H.323 callee URI, as per RFC 3508. The h323host must be specified in environments that are not managed by a H.323 gatekeeper. Note that this syntax is optimized to produce the simplest dial-string in typical GK-managed environments, viz. h323user@sgw-hostport. In an unmanaged environment, if one only has the H.323 host part, but the H.323 endpoint does not have an alias to use in the H.323 user-part, then one could include anything in the H.323 user-part, and the dial string could, for example, be as follows:

“0;h323host=192.168.112.188@mysgw”.

2. Providing the destination H.323 address as a H.323 URI

h323:{address}

| | | Required |
|---|---|---|
| Name | Description | field |
| address | H.323 address. | Yes. |
| | user / “@”hostport / user“@”hostport | |
| | (Please refer to RFC 3508 for formal syntax | |
| | definition.) | |

In an embodiment, the dial pattern is employed when the SIP-H.323 gateway receives an incoming INVITE where the “To” header or “Request-URI” contains the callee information provided as a H.323 URI. The SIP-H.323 gateway server will simply validate the URI and place an H.323 call. This pattern is highly recommended when the INVITEs are intercepted by a B2BUA, or a 3pcc server, before making it to the SGW.

3. Providing the Destination H.323 Address as a H.323 URI

tel:{global-number-digits}

| | | Required |
|---|---|---|
| Name | Description | field |
| global-number- | H.323 address. | Yes. |
| digits | “+” *phonedigit DIGIT *phonedigit | |
| | (Please refer to RFC 3966 for formal syntax | |
| | definition.) | |

In an embodiment, the dial pattern is employed when the SIP-H.323 gateway receives an incoming INVITE where the “To” header or “Request-URI” contains the callee information provided as a “tel:” URI. We currently support global-number types only, without supporting parameters to the URI. (The term “global-number-digits” should be interpreted per RFC 3966). The SIP-H.323 gateway server will simply validate the URI and place an H.323 call. This pattern is only useful for gatekeeper-managed environments. The value of the global-number-digits will be treated as an E.164 number for the outbound H.323 call.

Configuring the Outbound Dial Patterns Target

In an embodiment, the target for parsing out the H.323 destination information is configurable. This influences whether the SIP-H.323 gateway server will parse H.323 callee information from the “To” header or from the “Request-URI”. Note that the SIP header parsing rules will apply to the entire SIP dialog, and not just to the SIP transaction that started the dialog. The sgw.ini parameter: SIP_OutboundDialPatternUsesRequestURI is added to influence this behavior, and it is also configurable by using the XML-RPC API. The default value for this parameter is ‘False’, which means that the SIP-H.323 gateway server will parse the “To” header to get the H.323 callee information. When set value to ‘True’, the SIP-H.323 gateway server parse the “Request-URI” to get the H.323 callee's information. In the latter case, the user agent matching logic that is normally invoked as part of INVITE-processing will be bypassed by the SIP-H.323 gateway. This logic will be replaced to allow more flexibility in the request-URI.

The following new XML-RPC APIs are added to support this configuration:

sgwApiV1.SetOutboundDialPatternUsesRequestURI (...)
sgwApiV1.QueryOutboundDialPatternUsesRequestURI (...)

Examples Illustrating the Usage of Dial Patterns in Outbound Calls

In our examples, the SGW's IP address is 74.125.45.2, while the H.323 callee's IP address is 74.125.45.1, and their extension is “123”. The following illustrates the construction of the H.323 address by the SGW.

| Pattern | request-URI or “To:” field in the incoming SIP INVITE | H.323 URI constructed |
|---|---|---|
| 1 | sip:123;h323host=74.125.45.1;h323port=1725@74.125.45.2 | h323:123@74.125.45.1:1725 |
| | sip:123;h323host=74.125.45.1@74.125.45.2 | h323:123@74.125.45.1 |
| | sip:123@74.125.45.2 | h323:123 |
| 2 | h323:123@74.125.45.1 | h323:123@74.125.45.1 |
| | h323:123 | h323:123 |
| 3 | tel:123 | h323:123 |

Exemplary Computer Platform

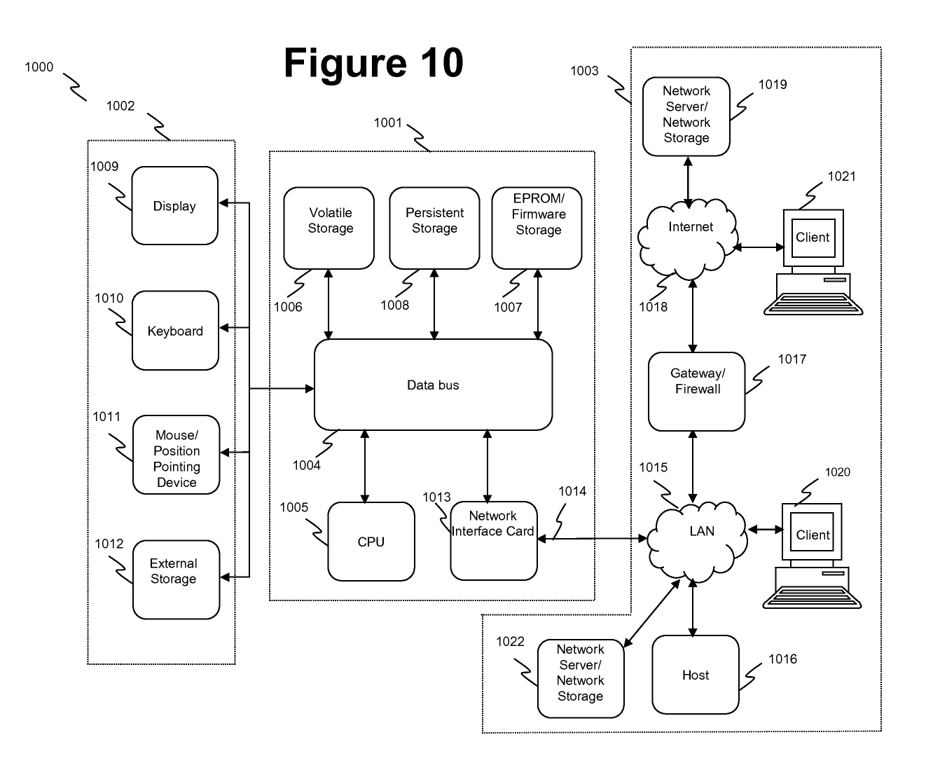

FIG. 10 illustrates an exemplary embodiment of a computer platform upon which the inventive system may be implemented. Specifically, FIG. 10 is a block diagram that illustrates an embodiment of a computer/server system 1000 upon which an embodiment of the inventive methodology may be implemented. The system 1000 includes a computer/server platform 1001, peripheral devices 1002 and network resources 1003.

The computer platform 1001 may include a data bus 1005 or other communication mechanism for communicating information across and among various parts of the computer platform 1001, and a processor 1005 coupled with bus 1001 for processing information and performing other computational and control tasks. Computer platform 1001 also includes a volatile storage 1006, such as a random access memory (RAM) or other dynamic storage device, coupled to bus 1005 for storing various information as well as instructions to be executed by processor 1005. The volatile storage 1006 also may be used for storing temporary variables or other intermediate information during execution of instructions by processor 1005. Computer platform 1001 may further include a read only memory (ROM or EPROM) 1007 or other static storage device coupled to bus 1005 for storing static information and instructions for processor 1005, such as basic input-output system (BIOS), as well as various system configuration parameters. A persistent storage device 1008, such as a magnetic disk, optical disk, or solid-state flash memory device is provided and coupled to bus 1001 for storing information and instructions.

Computer platform 1001 may be coupled via bus 1005 to a display 1009, such as a cathode ray tube (CRT), plasma display, or a liquid crystal display (LCD), for displaying information to a system administrator or user of the computer platform 1001. An input device 1010, including alphanumeric and other keys, is coupled to bus 1001 for communicating information and command selections to processor 1005. Another type of user input device is cursor control device 1011, such as a mouse, a trackball, or cursor direction keys for communicating direction information and command selections to processor 1005 and for controlling cursor movement on display 1009. This input device typically has two degrees of freedom in two axes, a first axis (e.g., x) and a second axis (e.g., y), that allows the device to specify positions in a plane.

An external storage device 1012 may be coupled to the computer platform 1001 via bus 1005 to provide an extra or removable storage capacity for the computer platform 1001. In an embodiment of the computer system 1000, the external removable storage device 1012 may be used to facilitate exchange of data with other computer systems.

The invention is related to the use of computer system 1000 for implementing the techniques described herein. In an embodiment, the inventive system may reside on a machine such as computer platform 1001. According to one embodiment of the invention, the techniques described herein are performed by computer system 1000 in response to processor 1005 executing one or more sequences of one or more instructions contained in the volatile memory 1006. Such instructions may be read into volatile memory 1006 from another computer-readable medium, such as persistent storage device 1008. Execution of the sequences of instructions contained in the volatile memory 1006 causes processor 1005 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1005 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 1008. Volatile media includes dynamic memory, such as volatile storage 1006.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 1005 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 1005. The bus 1005 carries the data to the volatile storage 1006, from which processor 1005 retrieves and executes the instructions. The instructions received by the volatile memory 1006 may optionally be stored on persistent storage device 1008 either before or after execution by processor 1005. The instructions may also be downloaded into the computer platform 1001 via Internet using a variety of network data communication protocols well known in the art.

The computer platform 1001 also includes a communication interface, such as network interface card 1013 coupled to the data bus 1005. Communication interface 1013 provides a two-way data communication coupling to a network link 1015 that is coupled to a local network 1015. For example, communication interface 1013 may be an integrated services digital network (ISDN) card or a modem to provide a data communication connection to a corresponding type of telephone line. As another example, communication interface 1013 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1013 sends and receives electrical, electromagnetic or optical signals that carry digital data streams representing various types of information.

Network link 1013 typically provides data communication through one or more networks to other network resources. For example, network link 1015 may provide a connection through local network 1015 to a host computer 1016, or a network storage/server 1017. Additionally or alternatively, the network link 1013 may connect through gateway/firewall 1017 to the wide-area or global network 1018, such as an Internet. Thus, the computer platform 1001 can access network resources located anywhere on the Internet 1018, such as a remote network storage/server 1019. On the other hand, the computer platform 1001 may also be accessed by clients located anywhere on the local area network 1015 and/or the Internet 1018. The network clients 1020 and 1021 may themselves be implemented based on the computer platform similar to the platform 1001.

Local network 1015 and the Internet 1018 both use electrical, electromagnetic or optical signals that carry digital data streams. The signals through the various networks and the signals on network link 1015 and through communication interface 1013, which carry the digital data to and from computer platform 1001, are exemplary forms of carrier waves transporting the information.

Computer platform 1001 can send messages and receive data, including program code, through the variety of network(s) including Internet 1018 and LAN 1015, network link 1015 and communication interface 1013. In the Internet example, when the system 1001 acts as a network server, it might transmit a requested code or data for an application program running on client(s) 1020 and/or 1021 through Internet 1018, gateway/firewall 1017, local area network 1015 and communication interface 1013. Similarly, it may receive code from other network resources.

The received code may be executed by processor 1005 as it is received, and/or stored in persistent or volatile storage devices 1008 and 1006, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in a teleconferencing system achieving interoperability between teleconferencing endpoints that follow different communication protocols. It is intended that the specification and examples be considered as exemplary only, with a true scope and spirit of the invention being indicated by the following claims.

What is claimed is:

1. A teleconferencing system for achieving interoperability between at least two of a first endpoint following SIP protocol, a second endpoint following H.323 protocol and a third endpoint following a proprietary protocol, the teleconferencing system comprising a signaling-only gateway and a call control server, wherein the signaling-only gateway and a call control server are operable to perform policy-based management of calls between the at least two of the first endpoint, the second endpoint and the third endpoint, enabling a direct flow of media data between respective endpoints.

2. The teleconferencing system of claim 1, wherein the signaling-only gateway and the call control server are additionally operable to perform at least one policy-based management function.

3. The teleconferencing system of claim 2, wherein the policy-based management comprises routing calls involving combinations of the at least two of the first endpoint, the second endpoint and the third endpoint based on proximity across at least one IP network using a pre-configured IP range to ensure selection of an optimal gateway from a set of infrastructure components and redirection of at least one of the first endpoint, the second endpoint and the third endpoint to alternate gateways, if dictated by a routing policy.

4. The teleconferencing system of claim 2, wherein the policy-based management comprises managing bandwidth and performing usage accounting for calls involving combinations of the at least two of the first endpoint, the second endpoint and the third endpoint.

5. The teleconferencing system of claim 2, wherein the policy-based management comprises seamlessly setting up and managing calls between the at least two of the first endpoint, the second endpoint and the third endpoint.

6. The teleconferencing system of claim 5, wherein seamlessly setting up calls comprises transfer, multiparty conferencing, and seamless conversion of calls involving the at least two of the first endpoint, the second endpoint and the third endpoint.

7. The teleconferencing system of claim 5, wherein seamlessly setting up calls comprises determining capability of at least one of the first endpoint, the second endpoint and the third endpoint and applying corresponding call control procedures needed to achieve a predetermined call setup operation.

8. A method for achieving interoperability between at least two of a first endpoint following SIP protocol, a second endpoint following H.323 protocol and a third endpoint following a proprietary protocol, the method being performed by a teleconferencing system comprising a signaling-only gateway and a call control server, the method comprising performing policy-based management of calls between the at least two of the first endpoint, the second endpoint and the third endpoint using the signaling-only gateway and the call control server to enable a direct flow of media data between respective endpoints.

9. The method of claim 8, wherein the signaling-only gateway and the call control server are operable to provide at least one policy-based management function.

10. The method of claim 9, wherein the policy-based management comprises routing calls involving combinations of the at least two of the first endpoint, the second endpoint and the third endpoint based on proximity across at least one IP network using a pre-configured IP range to ensure selection of an optimal gateway from a set of infrastructure components and redirection of at least one of the first endpoint, the second endpoint and the third endpoint to alternate gateways, if dictated by a routing policy.

11. The method of claim 9, wherein the policy-based management comprises managing bandwidth and performing usage accounting for calls involving combinations of the at least two of the first endpoint, the second endpoint and the third endpoint.

12. The method of claim 9, wherein the policy-based management comprises seamlessly setting up and managing calls between the at least two of the first endpoint, the second endpoint and the third endpoint.

13. The method of claim 12, wherein seamlessly setting up calls comprises transfer, multiparty conferencing, and seamless conversion of calls involving the at least two of the first endpoint, the second endpoint and the third endpoint.

14. The method of claim 12, wherein seamlessly setting up calls comprises determining capability of at least one of the first endpoint, the second endpoint and the third endpoint and applying corresponding call control procedures needed to achieve a predetermined call setup operation.

15. A computer-readable medium embodying computer-executable instructions, which, when executed by one or more processors of a teleconferencing system comprising a signaling-only gateway and a call control server, are operable to cause the one or more processors to perform a method for achieving interoperability between at least two of a first endpoint following SIP protocol, a second endpoint following H.323 protocol and a third endpoint following a proprietary protocol, the method comprising performing policy-based management of calls between the at least two of the first endpoint, the second endpoint and the third endpoint using the signaling-only gateway and the call control server to enable a direct flow of media data between respective endpoints.

16. The computer-readable medium of claim 15, wherein the policy-based management comprises routing calls involving combinations of the at least two of the first endpoint, the second endpoint and the third endpoint based on proximity across at least one IP network using a pre-configured IP range to ensure selection of an optimal gateway from a set of infrastructure components and redirection of at least one of the first endpoint, the second endpoint and the third endpoint to alternate gateways, if dictated by a routing policy.

17. The computer-readable medium of claim 15, wherein the policy-based management comprises managing bandwidth and performing usage accounting for calls involving combinations of the at least two of the first endpoint, the second endpoint and the third endpoint.

18. The computer-readable medium of claim 15, wherein the policy-based management comprises seamlessly setting up and managing calls between the at least two of the first endpoint, the second endpoint and the third endpoint.

19. The computer-readable medium of claim 18, wherein seamlessly setting up calls comprises transfer, multiparty conferencing, and seamless conversion of calls involving the at least two of the first endpoint, the second endpoint and the third endpoint.

20. The computer-readable medium of claim 18, wherein seamlessly setting up calls comprises determining capability of at least one of the first endpoint, the second endpoint and the third endpoint and applying corresponding call control procedures needed to achieve a predetermined call setup operation.
